(19) United States
(12) Patent Application Publication
(10) Pub. No.: US 2024/0364690 A1
(43) Pub. Date: Oct. 31, 2024

(54) Implementing Tenancies Of Different Tenancy Types In A Cloud Environment

(71) Applicant: Oracle International Corporation, Redwood Shores, CA (US)

(72) Inventors: Kristen Doherty, Encinitas, CA (US); Matthew Rushton, Portsmouth, NH (US); Richard Stockton, Minneapolis, MN (US)

(73) Assignee: Oracle International Corporation, Redwood Shores, CA (US)

(21) Appl. No.: 18/770,123

(22) Filed: Jul. 11, 2024

Related U.S. Application Data
(63) Continuation-in-part of application No. 18/639,806, filed on Apr. 18, 2024.
(60) Provisional application No. 63/462,878, filed on Apr. 28, 2023.

(51) Int. Cl. H04L 9/40

(52) U.S. Cl. CPC H04L 63/10

(57) ABSTRACT

Techniques for implementing tenancies in a cloud computing environment are disclosed. A set of tenancies is implemented, with the tenancies having a type attribute in metadata indicating that the tenancies are associated with a cloud provider. Another set of tenancies is implemented, the tenancies having a type attribute in the metadata indicating that the tenancies are associated with a cloud reseller. An additional set of tenancies is implemented with a type attribute in the metadata, indicating that the tenancies are associated with customer organizations.

### BENEFIT CLAIMS; RELATED APPLICATIONS; INCORPORATION BY REFERENCE

This application claims the benefit of U.S. Provisional Application 63/462,878 filed on Apr. 28, 2023 and U.S. Non-Provisional patent application Ser. No. 18/639,806 filed on Apr. 18, 2024, both of which are hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to systems and methods associated with a cloud infrastructure environment. In particular, the present disclosure relates to implementing tenancies of different types in a cloud infrastructure environment.

### BACKGROUND

A cloud computing environment can be used to provide access to a range of complementary cloud-based components, such as software applications or services, that enable organizations or enterprise customers to operate their applications and services in a highly available hosted environment.

The benefits to an organization in moving their application and service needs to a cloud environment include a reduction in the cost and complexity of designing, building, operating, and maintaining their own on-premise data center, software application framework, or other information technology infrastructure. Access to resources in a cloud environment may be restricted using a variety of mechanisms.

Infrastructure as a Service (IaaS) has emerged as a key component of cloud computing, providing organizations with scalable and flexible computing resources without the need to invest in and maintain physical hardware. IaaS allows businesses to subscribe to virtualized computing resources over the internet, such as servers, storage, and networking components. This model offers significant advantages, including cost savings on hardware, reduced overhead for maintenance and upgrades, and the ability to scale resources up or down based on demand. By leveraging IaaS, organizations can focus on their core business operations and application development rather than managing underlying infrastructure, leading to greater agility and efficiency in deploying and managing technology solutions.

IaaS platforms provide a range of services that enable users to quickly provision and manage virtual machines, configure networks, and store data securely. These services are typically accessed through a web-based interface or API, allowing for automation and integration with other software and services. IaaS providers, also referred to herein as cloud providers, offer security features, including identity and access management, encryption, and compliance certifications, ensuring that data and applications are protected. IaaS platforms also provide software offerings that customers can leverage. Flexibility and reliability make IaaS an attractive option for businesses, including those needing to scale quickly as well as large enterprises requiring robust and secure infrastructure solutions.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for providing a cloud infrastructure environment in accordance with an embodiment;

FIG. 2 further illustrates how a cloud infrastructure environment can be used to provide cloud-based applications or services or services in accordance with an embodiment;

FIG. 3 illustrates an example cloud infrastructure architecture in accordance with an embodiment;

FIG. 4 illustrates another example of a cloud infrastructure architecture in accordance with an embodiment;

FIG. 5 illustrates another example of a cloud infrastructure architecture in accordance with an embodiment;

FIG. 6 illustrates another example of a cloud infrastructure architecture in accordance with an embodiment;

FIG. 7 illustrates how the system can provide dedicated or private label cloud environments for use by tenants or customers of a cloud infrastructure environment in accordance with an embodiment;

FIG. 8 further illustrates the use of private label cloud realms for use by tenants or customers of a cloud infrastructure environment in accordance with an embodiment;

FIG. 9 further illustrates the use of private label cloud realms for use by tenants or customers of a cloud infrastructure environment in accordance with an embodiment;

FIG. 10 illustrates a system for providing access to software products or services in a cloud computing or other computing environment in accordance with an embodiment;

FIG. 11 illustrates a cloud environment in accordance with one or more embodiments;

FIG. 12 illustrates an example set of operations for implementing tenancies of multiple types in accordance with one or more embodiments; and

FIG. 13 illustrates an example set of operations for tenancy conversion in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD ENVIRONMENTS
3. CLOUD MANAGEMENT ARCHITECTURE
4. IMPLEMENTING TENANCIES OF MULTIPLE TYPES
5. TENANCY CONVERSION IN A CLOUD ENVIRONMENT
6. MISCELLANEOUS; EXTENSIONS

### 1. GENERAL OVERVIEW

One or more embodiments implement a set of cloud tenancies of different tenancy types in a cloud environment. The tenancy types include, for example, a cloud provider tenancy, a cloud reseller tenancy, and a customer organization tenancy. A cloud provider tenancy refers to an isolated partition within the cloud infrastructure environment where a cloud provider can create, organize, and administer cloud resources that provide services to cloud resellers and customer organizations of cloud resellers. A cloud reseller tenancy refers to an isolated partition within the cloud infrastructure environment where a cloud reseller can create, organize, and administer cloud resources that are used by the cloud reseller, and cloud resources that provide services to customer organizations of the cloud reseller. A customer organization tenancy refers to an isolated partition within the cloud infrastructure environment where a customer organization can create, organize, and administer cloud resources that are used by the customer organization. Metadata associated with each respective tenancy indicates the type of the tenancy.

One or more embodiments described in this Specification and/or recited in the claims may not be included in this General Overview section.

### 2. CLOUD ENVIRONMENTS

One or more embodiments provide features associated with dedicated or private label cloud (PLC) environments for use by tenants of a cloud infrastructure environment in accessing software products, services, or other offerings associated with the environment.

A cloud computing or cloud infrastructure environment can be used to provide access to a range of complementary cloud-based components, such as software applications or services, that enable organizations or enterprise customers to operate their applications and services in a highly available hosted environment.

The benefits to an organization in moving their application and service needs to a cloud infrastructure environment include a reduction in the cost and complexity of designing, building, operating, and maintaining their own on-premise data center, software application framework, or other information technology infrastructure.

### Cloud Infrastructure Environments

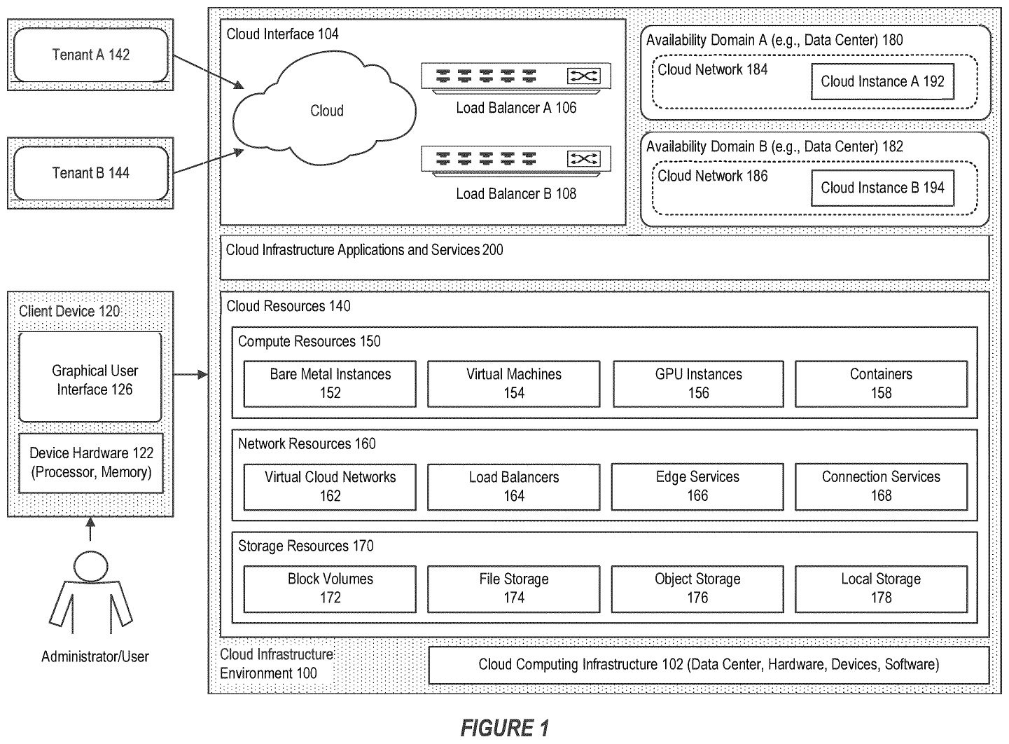

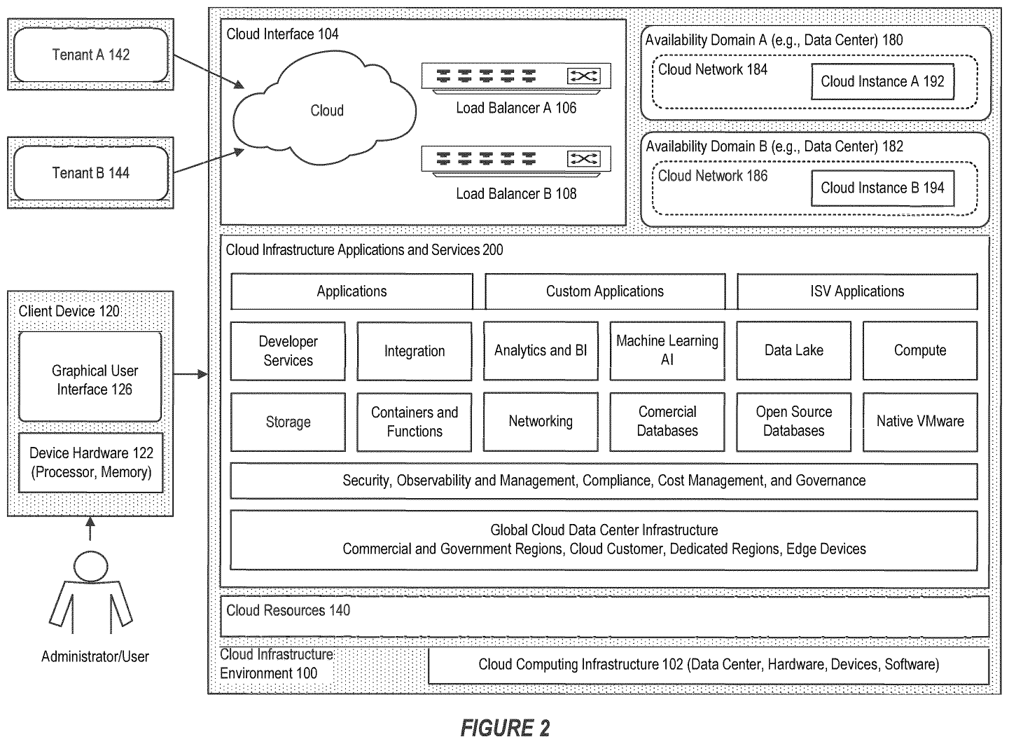

FIGS. 1 and 2 illustrate a system for providing a cloud infrastructure environment in accordance with an embodiment.

In accordance with an embodiment, the components and processes illustrated in FIG. 1, and as further described herein regarding various embodiments, can be provided as software or program code executable by a computer system or other type of processing device, for example, a cloud computing system.

The illustrated example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers A 106, B 108. Cloud interface 102 includes user interfaces and APIs provided by a cloud services provider for interacting with its cloud services. This includes tools and platforms that allow users and administrators to manage, configure, and monitor cloud resources and services. Cloud interface 102 may include a console, such as a web-based user interface that provides a visual way to interact with and manage cloud resources. Through the console, users may, for example, create, configure, and monitor cloud services like compute instances, databases, storage, and networking components. Cloud interface 102 may also include a command line interface for users who prefer to work with the cloud infrastructure using command-line tools. The CLI allows for scripting and automation of cloud management tasks in an embodiment.

In accordance with an embodiment, load balancer A 106 and load balancer B 108 are services that distribute incoming network traffic across multiple servers, instances, or other resources to ensure that no single resource bears too much demand. By spreading the requests evenly across the resources, load balancers enhance the responsiveness and availability of resources such as applications, websites, or databases. Load balancer A 106 and load balancer B 108 may be either public load balancers that are accessible from the Internet and used for distributing external traffic, or private load balancers that are used within a virtual cloud network (VCN) and are not accessible from the public Internet (and are therefore ideal for internal traffic distribution). In an embodiment, load balancer A 106 and load balancer B 108 are designed for high availability and fault tolerance and are implemented in a redundant configuration across multiple availability domains or fault domains.

In accordance with an embodiment, the cloud infrastructure environment supports the use of availability domains, such as availability domain A 180 and availability domain B 182, that enable customers to create and access cloud networks 184, 186, and run cloud instances A 192, B 194. In an embodiment, availability A 180 and availability domain B 182 may represent a data center, or a set of data centers located within a region. These availability domains may be isolated from each other, meaning that they may not share the same physical infrastructure such as power or cooling systems. This design provides a high degree of failure independence and robustness. In an embodiment, a fault domain may provide additional protection and resiliency within a single availability domain by grouping hardware and infrastructure within an availability domain that is isolated from other fault domains. This isolation may be in terms of electricity, cooling, and other potential sources of failure.

In accordance with an embodiment, a tenancy (a container for resources used by a tenant) can be created for each cloud tenant/customer, for example, tenant A 142, B 144, that provides a secure and isolated partition within the cloud infrastructure environment where the customer can create, organize, and administer their cloud resources. A cloud tenant/customer can access an availability domain and a cloud network to access each of their cloud instances. A tenancy in is isolated from other tenancies, ensuring that each customer's data and resources are secure and inaccessible to others. Within a tenancy, customers can create, manage, and organize a wide range of cloud resources, including compute instances, storage volumes, and networks. In Identity and Access Management (IAM) service enables the management of users, groups, and policies within a tenancy. Through IAM, customers can control who has access to their resources and what actions they can perform. The tenancy is also the level where billing and subscription management are handled. Usage and costs associated with the resources within a tenancy are tracked and billed collectively under that tenancy. Each tenancy may be associated with specific service limits and quotas for various resources. These limits may be used to help manage capacity and facilitate resource distribution across each tenant.

In accordance with an embodiment, a computing device, such as a client device 120 having a device hardware 122 (e.g., processor, memory) and graphical user interface 126, can enable an administrator or other user to communicate with the cloud infrastructure environment via a network, such as a wide area network, a local area network, or the Internet, to create or update cloud services.

In accordance with an embodiment, the cloud infrastructure environment provides access to shared cloud resources 140 via, for example, a compute resources layer 150, a network resources layer 160, and/or a storage resources layer 170. Customers can launch cloud instances as needed to meet compute and application requirements. After a customer provisions and launches a cloud instance, the provisioned cloud instance can be accessed from a client device such as client device 120.

In accordance with an embodiment, compute resources 150 can comprise resources, such as bare metal cloud instances 152, virtual machines 154, graphical processing unit (GPU) compute cloud instances 156, and/or containers 158. A bare metal instance represents a physical server with dedicated hardware that is fully allocated to a single tenant. A bare metal instance provides direct access to the server's processor, memory, storage, and other hardware resources. A virtual machine (VM) is a software emulation of a physical computer that runs an operating system and applications like a physical computer. VMs allow multiple operating systems to run on a single physical machine or across multiple machines. A hypervisor layer resides between the hardware and the virtual machines, allocating physical resources (like CPU, memory, and storage) to each VM. In an embodiment, GPU compute cloud instances provide GPUs along with traditional CPU resources. These instances are designed for tasks that require significant parallel processing power, making them ideal for applications like machine learning, scientific computing, 3D rendering, and video processing. In an embodiment, Containers 158 use a method of virtualization that allows for the running of multiple isolated applications on a single control host, virtualizing the operating system. Each container shares the host system's kernel but runs in an isolated user space, making containers lightweight and efficient.

The components of the compute resources 150 can be used to provision and manage bare metal compute cloud instances or provision cloud instances as needed to deploy and run applications, as in an on-premises data center. For example, in accordance with an embodiment, the cloud infrastructure environment can provide control of physical host (bare metal) machines within the compute resources layer that run as compute cloud instances directly on bare metal servers without a hypervisor.

In accordance with an embodiment, the cloud infrastructure environment can also provide control of virtual machines within the compute resources layer that can be launched, for example, from an image, wherein the types and quantities of resources available to a virtual machine cloud instance can be determined, for example, based upon the image that the virtual machine was launched from.

In accordance with an embodiment, the network resources layer can comprise several network-related resources, such as virtual cloud networks (VCNs) 162, load balancers 164, edge services 166, and/or connection services 168. In an embodiment, a virtual cloud network (VCN) is a customizable and private network in a cloud environment. A VCN provides a virtual version of a traditional network, including subnets, route tables, and gateways. It allows users to set up their cloud-based network architecture according to their requirements. In an embodiment, edge services 166 include services and technologies designed to bring computation, data storage, and networking capabilities closer to the location where they are needed. Edge services 166 may be used to optimize traffic, reduce latency, or provide other advantages.

In accordance with an embodiment, the storage resources layer can comprise several resources, such as data/block volumes 172, file storage 174, object storage 176, and/or local storage 178. Data/block volumes 172 provide unformatted block-level storage that can be used to create file systems that host databases or for other purposes requiring unformatted storage. File storage 174 provides a file system in an embodiment and may offer shared file systems that multiple instances can access concurrently using standard file storage protocols. Object storage 176 manages data as objects within storage buckets. Objects have certain attributes that may include data, metadata, and a unique identifier. Local storage 178 refers to storage devices that are physically attached to the host computer.

As illustrated in FIG. 2, in accordance with an embodiment, the cloud infrastructure environment can include a range of complementary cloud-based components, such as cloud infrastructure applications and services 200, that enable organizations or enterprise customers to operate their applications and services in a highly available hosted environment.

In accordance with an embodiment, a self-contained cloud region can be provided as a complete, e.g., Oracle Cloud Infrastructure (OCI), dedicated region within an organization's data center that offers the data center operator the agility, scalability, and economics of an e.g., OCI public cloud, while retaining full control of their data and applications to meet security, regulatory, or data residency requirements.

For example, in accordance with an embodiment, such an environment can include racks physically and logically managed by a cloud infrastructure provider (e.g., Oracle), customer's racks, access for cloud operations personnel for setup and hardware support, customer's data center power and cooling, customer's floor space, an area for customer's data center personnel, and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's (e.g., Oracle's) public cloud regions, for example, ERP, Financials, HCM, and SCM. A customer can seamlessly lift and shift legacy workloads using the cloud infrastructure provider's services (e.g., bare metal compute, VMs, and GPUs), database services (e.g., Oracle Autonomous Database), or container-based services (e.g., Oracle Container Engine for Kubernetes).

In accordance with an embodiment, a cloud infrastructure environment can operate according to an infrastructure-as-a-service (IaaS) model that enables the environment to provide virtualized computing resources over a public network (e.g., the Internet)

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components; example services include billing software, monitoring software, logging software, load balancing software, or clustering software. Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not, be a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries or daemons). This is often managed by the cloud infrastructure provider below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like).

In accordance with an embodiment, IaaS provisioning may refer to acquiring computers or virtual hosts for use and installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on others, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various geographic locations). However, in some examples, the infrastructure where the code will be deployed requires provisioning. In some instances, the provisioning can be done manually, a provisioning tool may be utilized to provision the resources, and/or deployment tools may be utilized to deploy the code once the infrastructure is provisioned.

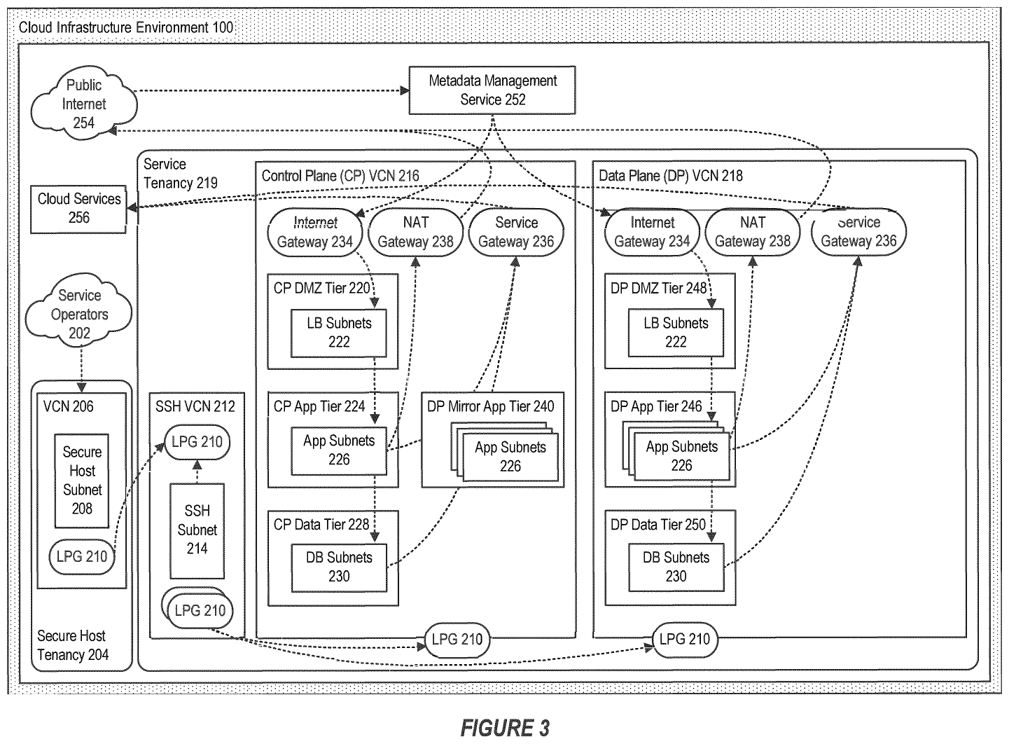

FIG. 3 illustrates an example cloud infrastructure architecture in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices that may be portable handheld devices (e.g., a telephone, a computing tablet, a personal digital assistant (PDA)) or wearable devices (e.g., a head mounted display), running software such as Microsoft Windows, and/or a variety of mobile operating systems, such as iOS, Android, and the like, and being Internet, e-mail, short message service (SMS), or other communication protocol enabled. Alternatively, the client computing devices can be general purpose personal computers including, for example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems such as Chrome OS. Additionally, or alternatively, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnets 222, a control plane app tier 224 that can include app subnets 226, and a control plane data tier 228 that can include database (DB) subnets 230 (e.g., frontend DB subnet(s) and/or backend DB subnet(s)). The LB subnet(s) contained in the control plane DMZ tier can be communicatively coupled to the app subnet(s) contained in the control plane app tier and to an Internet gateway 234 that can be contained in the control plane VCN. The app subnet(s) can be communicatively coupled to the DB subnet(s) contained in the control plane data tier, a service gateway 236, and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier, a data plane DMZ tier, and a data plane data tier. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way; the service gateway can make API calls to cloud services, and cloud services can send requested data to the service gateway. Generally, cloud services may not initiate API calls to the service gateway.

In accordance with an embodiment, the secure host tenancy can be directly connected to the service tenancy that may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example, create, read, update, or delete (CRUD) operations through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both that may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage that may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy that may be isolated from the public Internet.

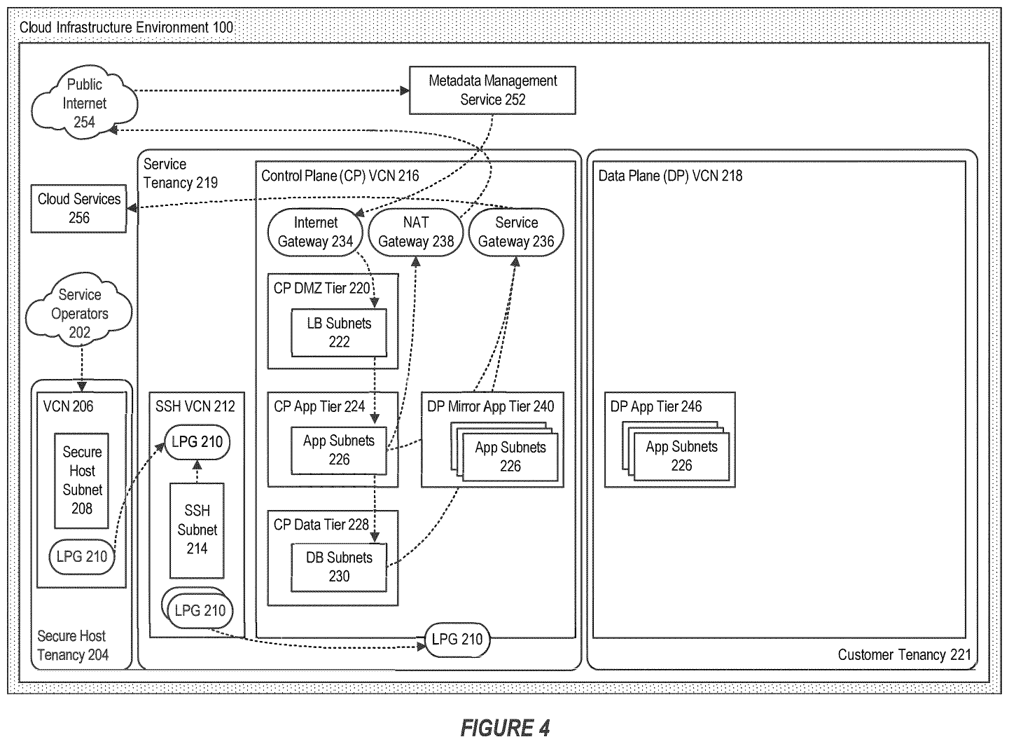

FIG. 4 illustrates another example of a cloud infrastructure architecture in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources provisioned in the control plane VCN contained in the service tenancy to be deployed or otherwise used in the data plane VCN contained in the customer tenancy.

In accordance with an embodiment, a customer of the cloud infrastructure provider may have databases that are managed and operated within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but the data plane mirror app tier may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, by the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with, Deployment 1 in Region 2.

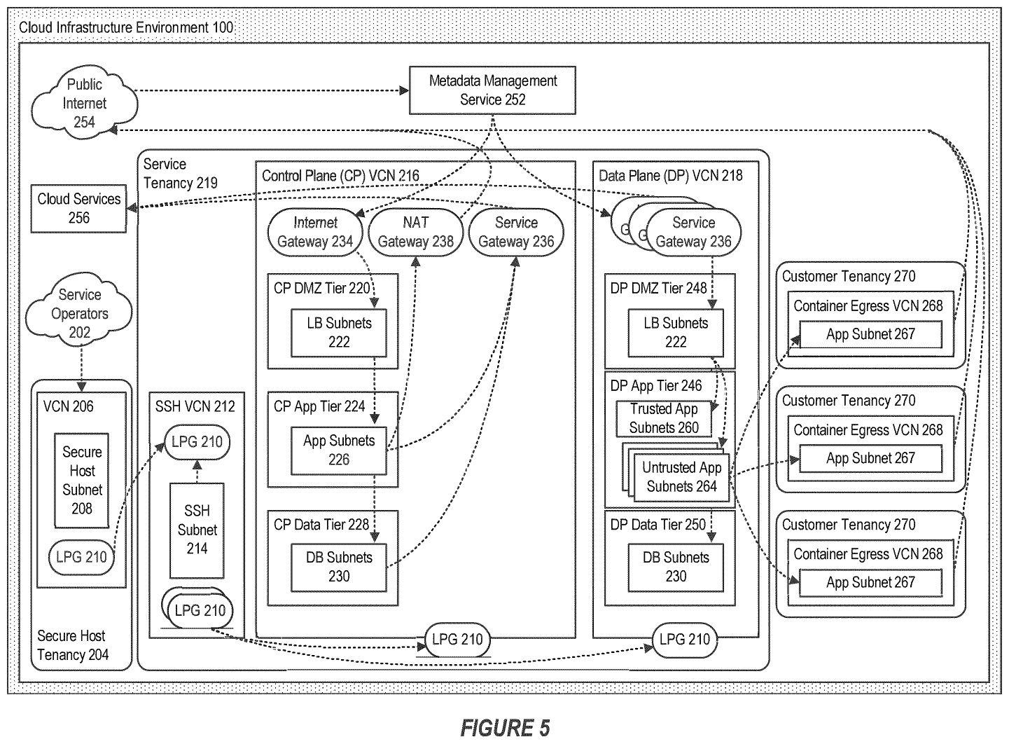

FIG. 5 illustrates another example of a cloud infrastructure architecture in accordance with an embodiment.

As illustrated in FIG. 5, in accordance with an embodiment, the trusted app subnets 260 can be communicatively coupled to the service gateway contained in the data plane VCN, the NAT gateway contained in the data plane VCN, and DB subnet(s) contained in the data plane data tier. The untrusted app subnets 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)) that may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s) and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled, or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

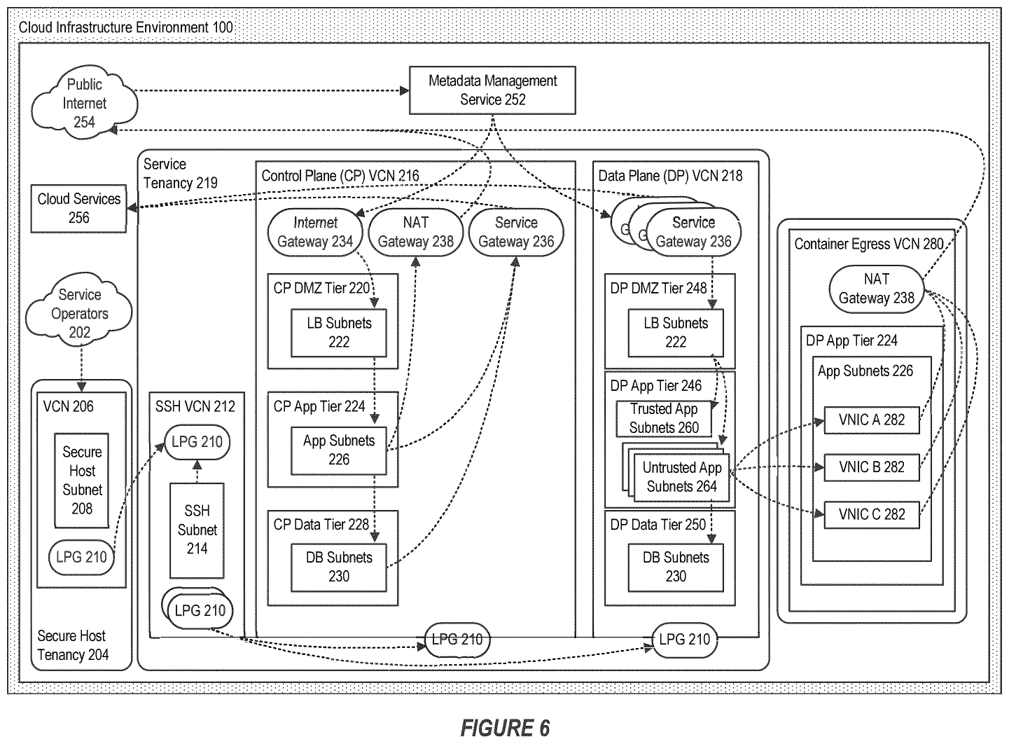

FIG. 6 illustrates another example of a cloud infrastructure architecture in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container and be communicatively coupled to an app subnet that can be contained in a data plane app tier that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that request a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining that the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Private Label Cloud Environments

In accordance with an embodiment, a cloud infrastructure environment can be used to provide dedicated cloud environments, for example, as one or more private label cloud environments for use by tenants of the cloud infrastructure environment in accessing subscription-based software products, services, or other offerings associated with the cloud infrastructure environment.

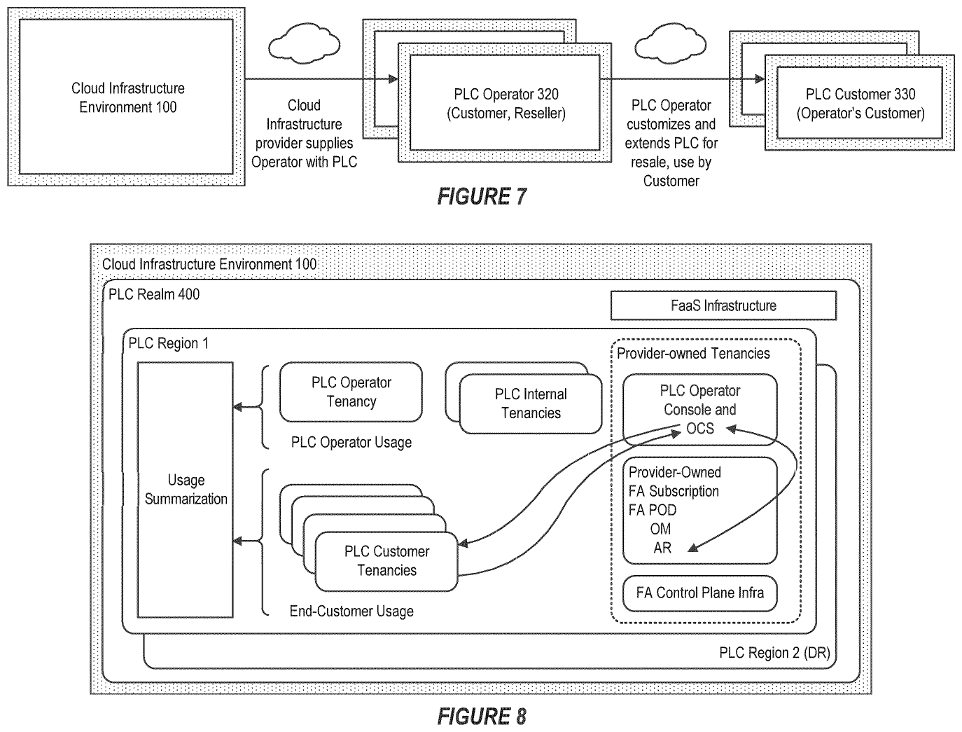

FIG. 7 illustrates how the system can provide dedicated or private label cloud environments for use by tenants or customers of a cloud infrastructure environment in accordance with an embodiment.

As illustrated in FIG. 7, in accordance with an embodiment, a cloud infrastructure provider (e.g., OCI) can supply a PLC operator 320, for example an OCI customer operating as a reseller, with one or more private label cloud (PLC) environments. The PLC operator/reseller can then customize and extend the private label cloud for use by (their) customer 330 for use in accessing subscription-based software products, services, or other offerings associated with the cloud infrastructure environment.

For purposes of illustration, examples of such subscription-based products, services, or other offerings may include various Oracle Cloud Infrastructure software products, Oracle Fusion Applications products, or other types of products or services that allow customers to subscribe to usage of those products or services.

FIG. 8 further illustrates the use of private label cloud realms for use by tenants or customers of a cloud infrastructure environment in accordance with an embodiment.

As illustrated in FIG. 8, in accordance with an embodiment, the system can include a cloud subscription service or component, such as an Oracle Cloud Subscriptions (OCS) service or component, that exposes one or more subscription management APIs for creating orders used to onboard new customers or to launch a workflow that creates a subscription and orchestrates billing and pricing service or other components for use with a PLC realm 400.

In accordance with an embodiment, when a PLC operator/reseller or their customer requests a PLC environment, the system creates a PLC realm for use with one or more provider-owned tenancies. A realm is a logical collection of one or more cloud regions that are isolated from each other and do not allow customer content to traverse realm boundaries to a region outside that realm. Each realm is accessed separately. PLC operators access cloud resources and services through a cloud tenancy. A cloud tenancy is a secure and isolated partition of a cloud infrastructure environment, and it only exists in a single realm. Within this tenancy, operators can access services and deploy workloads across all regions within that realm if policies allow.

In accordance with an embodiment, a first step in the process is to create an operator tenancy for the PLC operator before the realm and associated regions are turned over to them for subsequent management. The PLC operator then becomes the administrator of this tenancy with the ability to view and manage everything that happens within that realm, including their customer accounts and usage by those customers of cloud resources.

Generally, once the realm has been turned over or provided to the PLC operator, the cloud infrastructure provider cannot subsequently access the data within the operator tenancy unless the operator authorizes the cloud infrastructure provider to do so, for example, to provide troubleshooting for issues that may arise.

In accordance with an embodiment, the PLC operator can then create additional internal tenancies, intended for their own use internally, for example, to assess what the end customer experience will be, to provide a sales demo tenancy, or to operate a database for their own internal use. The operator can also create one or more customer tenancies that the end customer will be the administrator for. Cloud infrastructure usage metrics, for example, compute usage, storage usage, and usage of other infrastructure resources, may be consolidated by the operator, reflecting both operator usage and customer usage. Cloud infrastructure usage may be reported to the cloud infrastructure provider.

In accordance with an embodiment, a user interface or console can be provided that allows the PLC operator to manage its customer accounts and customer-offered services. A cloud infrastructure provider can also use a cloud infrastructure tenancy, for example, a Fusion Applications tenancy, to install any needed infrastructure services for use by the operator and their customers.

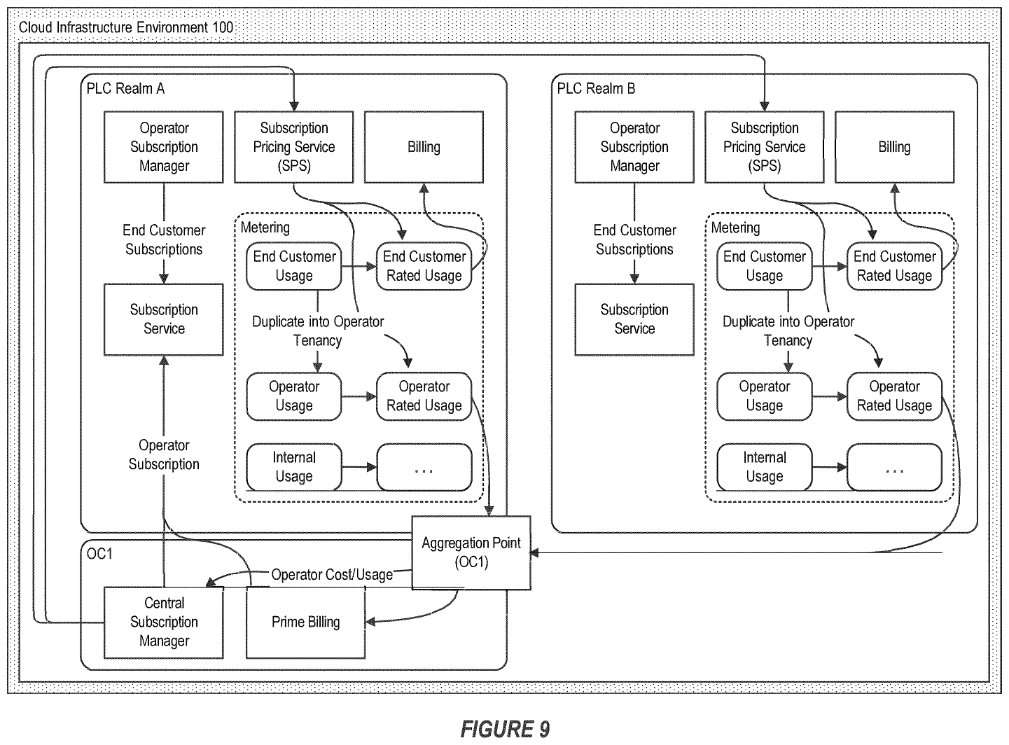

FIG. 9 further illustrates the use of private label cloud realms for use by tenants or customers of a cloud infrastructure environment in accordance with an embodiment.

As illustrated in FIG. 9, in accordance with an embodiment, a cloud subscription service or component exposes one or more subscription management APIs for creating orders used to onboard new customers or to launch a workflow that creates a subscription and orchestrates billing and pricing services or other components.

In accordance with an embodiment, the system can also include a billing service or component that operates upon a billing account or logical container of subscriptions and preferences used to produce an invoice for a customer.

In accordance with an embodiment, the system can also include a subscription pricing service (SPS) or component that operates upon a product catalog that defines the products that can be purchased by a customer. The subscription pricing service can also be used to provide a price list (e.g., a rate card) that the pricing service also owns.

In accordance with an embodiment, to support the sales process used to create a subscription in a PLC realm, products can be selected from a product hub. Once an order is created, a subscription is created in cloud subscription service that thereafter manages the life cycle of that subscription and provisions what needs to be provisioned in downstream services. The SPS component then manages the aspects of pricing and usage for use in charging the end cost to the PLC operator or their ability to charge their customers. Usage events are forwarded to the billing service or component, where, depending on the billing preferences of the subscription, invoices are created and pushed to an accounts receivables component.

In accordance with an embodiment, although the services that are offered in a realm report their usage to a metering service or component, such usage does not have any price associated with it. A rating process determines how much each specific event costs, for example, by applying rate cards, determines a unit and cost for that subscription, associates the cost to that record, and then forwards that to the billing service or component.

As further illustrated in FIG. 9, in accordance with an embodiment, a PLC operator may control multiple realms A, B. For, example an operator that operates in multiple countries may wish to operate a data center that is completely isolated for the United States of America and a separate data center that is completely isolated for Europe, for example, to address governance or regulatory requirements. In accordance with an embodiment, the usage associated with these multiple realms can be aggregated for use in billing the operator.

The examples of various systems illustrated above are provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Private Label Cloud Subscriptions

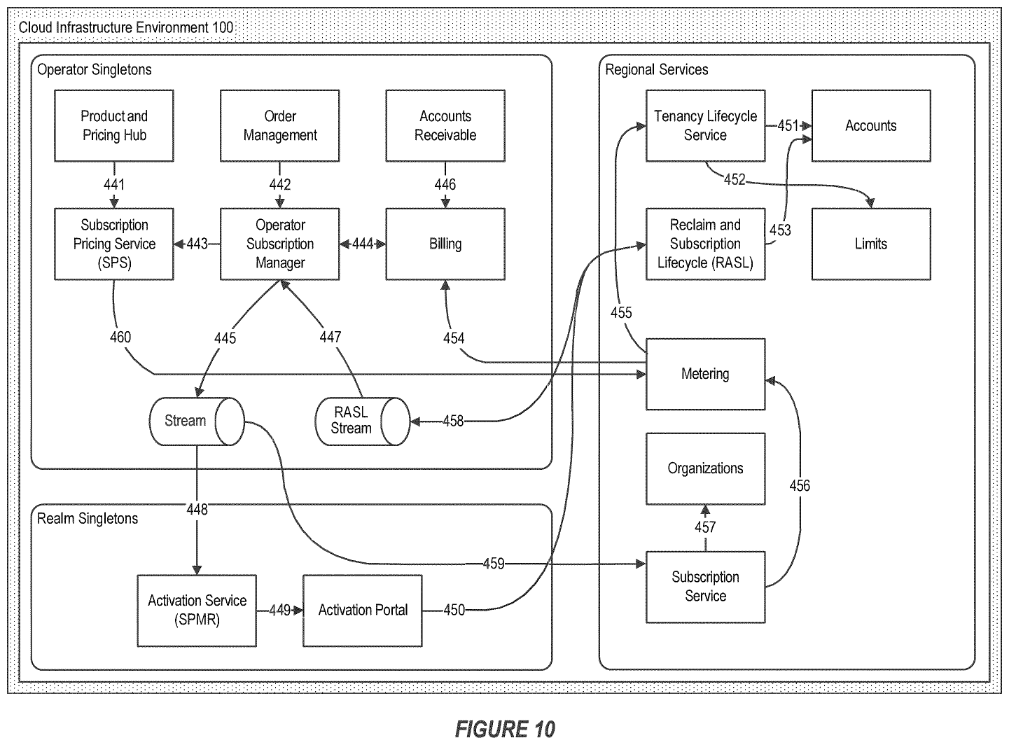

FIG. 10 illustrates a system for providing access to software products or services in a cloud computing or other computing environment in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various Oracle Cloud Infrastructure (OCI) software products, Oracle Fusion Applications products, or other types of products or services that allow customers to subscribe to usage of those products or services.

In accordance with an embodiment, a subscription can include artifacts, such as products, commits, billing model, and state. The cloud subscription service can expose one or more subscription management APIs for creating orders used to onboard new customers or to launch a workflow that creates a subscription and orchestrates creating the proper footprints in billing and pricing service or components as further described below.

In accordance with an embodiment, the billing service or component operates upon a billing account or logical container of subscriptions and preferences used to produce an invoice. Each billing account generates one or more invoices per billing cycle. The billing service includes a first pipeline that accepts usage and cost from a metering service or component. Usage may be accepted through a REST API or another interface. The billing service writes the usage to a database from which balances may be calculated and aggregated by the billing service or other services. The billing service may include a second pipeline responsible for taking the aggregated usage and commitments and calculating charges over one or more billing intervals.

In accordance with an embodiment, the subscription pricing service (SPS) or component operates upon a product catalog that defines the products that can be purchased by a customer. The product catalog forms the backbone of a price list (i.e., rate card) that the pricing service also owns. Rate cards are modeled as pricing rules on top of public list prices. The pricing service maintains a single price list for each product; new product prices can be added, and existing prices changed. The price list has a full history, the latest version being the current rate card. Since some contracts may require a snapshot of the rate card be taken, the pricing service handles this by recording the time a customer's rate card is created and then querying the price list at that time.

In accordance with an embodiment, the SPS or pricing service is responsible for providing information about products, global price lists, and end customer subscription specific price lists and discounts. For example, in accordance with an embodiment, the SPS can sync product information from a product hub (e.g., an Oracle Fusion Product Hub) and a global price list from a pricing hub (e.g., an Oracle Fusion Pricing Hub).

In accordance with an embodiment, the cloud subscription service operates as an upstream service to receive new order requests, for example, from an Oracle Fusion Order Management environment. The cloud subscription service can provide subscription information to the SPS service. Subscription details like time of quote, configuration, and subscription type (Commitment, PayG) help SPS to determine an effective base price (Rate Card) for the subscription. The cloud subscription service can also send discounts for subscriptions received, for example, from Oracle Fusion Order Management, that SPS stores as a pricing rule entity.

In accordance with an embodiment, the SPS service runs as a background process to manage a rate cards service or component responsible for generating rate cards for new subscriptions and updating when new price changes occur. The SPS service can expose APIs to access rate cards and pricing rules. A metering in-line rating engine can utilize these APIs to get subscription-specific rate cards and pricing rules using this data for cost calculations.

In accordance with an embodiment, additional SPS components can include, for example, a Pricing/Product Hub Oracle Integration Cloud (OIC) integration component, that allows a PLC operator entity providing subscription-based products, services, or other offerings within the environment to manage their product and price list, for example, as provided by an Oracle Fusion Product Hub and Oracle Fusion Pricing Hub, respectively.

For example, in accordance with such an embodiment, an SPS OIC product integration flow can listen to create/update events in the Product Hub and make calls to an SPS product API. Similarly, an SPS OIC pricing integration flow can pull new price list creations from the Pricing Hub and call respective SPS pricing APIs.

In accordance with an embodiment, the system can also include an SPS core module that provides APIs to manage and access pricing entities. Pricing can be accessed by internal services, such as an inline rating engine.

In accordance with an embodiment, the system can also include a rate card manager component. The SPS service maintains the single base price for a product at a given time. However, product prices for subscriptions are dependent on a base price at quote configuration time and price list change policy attributes of subscriptions. The SPS service internally maintains the price to be used for subscriptions using these properties. Such price lists are grouped in a rate card. The rate card manager can create and maintain the rate card as well as listen to price list changes and update existing rate cards with the new price. It also listens to new subscriptions and assigns the rate card based on subscription properties.

In accordance with an embodiment, the system can also include a rule decoder engine. The SPS service is responsible for managing pricing rules for a subscription, including discounts offered to an end customer. Pricing rules eligibility can be based on attributes of Products, like Discount group, Product Category, or specific SKUs. Internally, SPS needs to identify the list of products these rules will be applicable. To accomplish this, the rule decoder engine can compile the pricing rules in a format such that an in-line rating engine can consume for cost calculation. This compilation process can be triggered when products or pricing rules get created/updated.

As illustrated by way of example in FIG. 10, in accordance with an embodiment: at 441, a product and price information managed in, e.g., Fusion Applications, is sent to the SPS component. At 442, orders are sent to the cloud subscription service component to create subscriptions, rate cards, and billing accounts. At 443, pricing configuration and pricing rules are sent to SPS for new orders. At 444, the cloud subscription service is used to set up a billing account in the billing service or component. At 445, the cloud subscription service publishes events to a cloud infrastructure streaming component. At 446, charge data is sent to an accounts receivable component to generate invoices. At 447, cloud subscription service consumes reclaim and subscription lifecycle (RASL) events from cloud infrastructure streaming. At 448, an activation service reads the cloud subscription service event stream. At 449, a customer gets activation data from a portal. At 450, a tenancy lifecycle service provisions a tenancy as part of the subscription activation. At 451, the tenancy lifecycle service creates an accounts footprint during account provisioning. At 452, the tenancy lifecycle service sets a limits template during account provisioning. At 453, the accounts component acts as a downstream RASL client to handle legacy reclamation. At 454, aggregated cost and usage is sent to the billing service or component. At 455, an organization can create child tenancies using the tenancy lifecycle service. At 456, a metering service or component gets subscription mapping data. At 457, the subscription service gets organization data for subscription mappings. At 458, RASL reads cloud subscription service event stream. At 459, the subscription service reads cloud subscription service event stream; and at 460, the metering service or component gets a rate card data for each subscription that can then be used in charging the end cost to the PLC operator or their ability to charge their customers.

The above example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### 2. CLOUD MANAGEMENT ARCHITECTURE

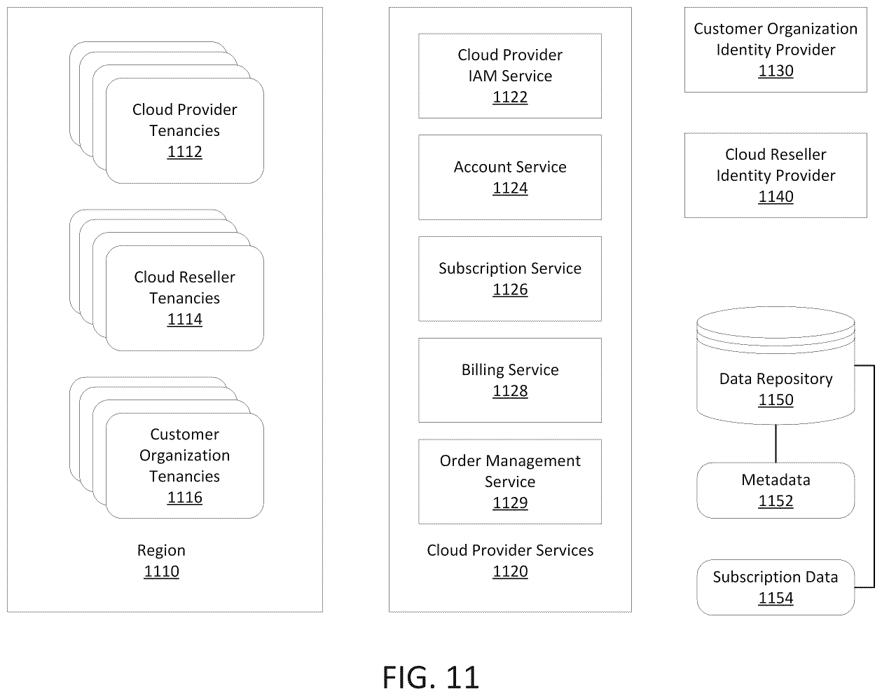

FIG. 11 illustrates a cloud environment in accordance with one or more embodiments. As illustrated in FIG. 11, region 1110 includes cloud provider tenancies 1112, cloud reseller tenancies 1114, and customer organization tenancies 1116. Cloud provider services 1120 includes cloud provider IAM service 1122, account service 1124, subscription service 1126, billing service 1128, and order management service 1129. The cloud environment also includes customer organization identity provider 1130, cloud reseller identity provider 1140, and data repository 1150. Data repository 1150 includes metadata 1152 and subscription data 1154. In one or more embodiments, the cloud environment may include more or fewer components than the components illustrated in FIG. 11. The components illustrated in FIG. 11 may be local to or remote from each other. The components illustrated in FIG. 11 may be implemented in software and/or hardware. Each component may be distributed over multiple applications and/or machines. Multiple components may be combined into one application and/or machine. Operations described with respect to one component may instead be performed by another component.

In one or more embodiments, region 1110 is a dedicated region provided by a cloud provider for a cloud reseller as an IaaS offering. The cloud provider may establish physical data centers with the necessary hardware and networking components to support the region. This includes deploying servers, storage systems, and networking equipment that conform to the cloud provider's infrastructure standards. The underlying cloud infrastructure is configured with cloud infrastructure software, virtual networks, compute instances, and storage services. In an embodiment, the environment is integrated with the cloud provider's management and monitoring tools that enable the cloud reseller to manage and monitor resources. Identity and access management (IAM), encryption, and compliance configurations are implemented according to the cloud provider's standards. Region 1110 is connected to the cloud provider's network in an embodiment. In accordance with an embodiment, once the infrastructure setup is complete, the reseller is then provided with administrative access to the region, enabling users associated with the reseller to deploy and manage cloud services for customer organizations of the cloud reseller (cloud reseller's end customers). For purposes of clarity, cloud provider is a provider of infrastructure to third parties, including cloud resellers. Cloud resellers may “white label” the infrastructure, selling it to customer organizations. The customer organizations, therefore, may be unaware of cloud provider's involvement (or level of involvement) in the provisioning of cloud services to the customer organization.

In one or more embodiments, cloud provider tenancies 1112 are tenancies that are controlled by the cloud provider. Cloud provider tenancies 1112 are logically separated from cloud reseller tenancies 1114 and customer organization tenancies 1116 although cloud provider tenancies 1112 are associated with the same region 1110 as cloud reseller tenancies 1114 and customer organization tenancies 1116 in an embodiment. Users associated with the cloud provider may create, manage, and operate cloud resources, such as virtual machines, databases, storage, and networking components associated with cloud provider tenancies 1112 in an embodiment.

In accordance with one or more embodiments, cloud provider services 1120 may be provisioned within cloud provider tenancies 1112. For example, cloud provider IAM service 1122, account service 1124, subscription service 1126, billing service 1128, and order management service 1129 may be assigned to a cloud provider tenancy. In an embodiment, cloud provider tenancies 1112 are configured to allow resources in cloud reseller tenancies and customer organization tenancies to access some of the resources associated with cloud provider tenancies. For example, API calls, network peering, shared services, or cross-tenancy identity and access management configurations may enable secure and controlled interactions between different tenancies. Resources like databases, storage, and services can be shared or utilized across multiple tenancies while maintaining isolation and security by using APIs and other access mechanisms. Access controls and permissions are set up to manage, monitor, and log cross-tenancy interactions in an embodiment.

In one or more embodiments, cloud provider tenancies 1112 are created by the cloud provider after the cloud provider provisions the region 1110. The region 1110 is created after the cloud provider provisions a realm where the region 1110 will reside. Cloud provider tenancies 1112 may be created before any cloud reseller tenancies 1114 and customer organization tenancies 1116 are created to ensure that certain cloud services, such as cloud provider services 1120, are available to cloud reseller tenancies 1114 and customer organization tenancies 1116.

In one or more embodiments, cloud reseller tenancies 1114 may include cloud reseller initial tenancies or cloud reseller internal tenancies. A cloud reseller initial tenancy is created by the cloud provider before the cloud provider transfers control of the region to the cloud reseller. Once control of the region has been handed over to the cloud reseller by the cloud provider, a cloud reseller initial tenancy is used by the cloud reseller to manage cloud services, including certain cloud services provided by the cloud service provider and cloud services unique to the cloud reseller in an embodiment. For example, cloud reseller employees have user accounts associated with the initial tenancy or that otherwise have access to the initial tenancy.

In accordance with one or more embodiments, cloud reseller internal tenancies are used to create a logical separation between the region management services and other services. The term “internal” represents a tenancy type that indicates the tenancy is internal to the cloud reseller or that resources associated with the tenancy are controlled by the cloud reseller. Accounting, billing, and other services may reside within a cloud reseller internal tenancy, while cloud region management service reside within a cloud reseller initial tenancy that was created for the purpose of managing cloud services within the region. By separating these services using tenancies, different configurations that are tenancy-specific may be used to ensure that the appropriate user have access to the services associated with their function. For example, users of the accounting services may not require access to management services, and users of the management services may not require access to accounting services.

In one or more embodiments, customer organization tenancies 1116 are tenancies used by customers of the cloud reseller. Customer organization tenancies 1116 are external from the perspective of the cloud reseller and may be referred to herein as external tenancies or of an external tenancy type. Customer organization tenancies 1116 are controlled by users of the associated customer organization to the extent that the cloud reseller has transferred administrative access to customer organization users and administrators. In accordance with an embodiment, a variety of resources available to other tenancies described herein may also be associated with customer organization tenancies 1116, such as compute instances, storage volumes, and networks. Customer organizations may rely on customer organization tenancies 1116 to logically separate groups of services, similar to the logical separation discussed in connection with cloud reseller tenancies 1114.

In one or more embodiments, cloud provider services 1120 represents a logical grouping for illustration purposes. The services shown as cloud provider services 1120 are associated with the cloud provider in an embodiment and may reside within one or more cloud provider tenancies such as cloud provider tenancies 1112.

In one or more embodiments, cloud provider IAM service 1122 is an identity and access management service controlled by the cloud provider. In an embodiment, cloud provider IAM service 1122 manages and secures access to cloud resources. Cloud provider IAM service 1122 enables administrators to define and enforce policies that control who can access specific resources and what actions they can perform. The cloud provider IAM service 1122 allows the creation of users, groups, and roles, and the assignment of permissions to them. This ensures that only authorized individuals or systems can interact with data and services. The cloud provider IAM service 1122 supports fine-grained access control by granting the necessary permissions required for tasks and integrates with other security features, such as multi-factor authentication (MFA) and audit logging, to enhance security and provide visibility into access patterns and potential security incidents.

In accordance with an embodiment, cloud provider IAM service 1122 may perform both the identity provider function and the access management function. The identity function and the access management function serve distinct roles within the IAM framework. The identity function focuses on verifying and managing user identities, encompassing several tasks, such as user registration, authentication, and maintenance of user credentials. The identity function ensures that each user is uniquely identifiable within the system and can prove their identity through authentication mechanisms like passwords, biometrics, or multi-factor authentication (MFA). The access management function governs what authenticated users are authorized to do within the cloud environment. The access management function involves defining and enforcing policies that specify the resources in the cloud environment that users can access and what actions they can perform. Access management ensures that users operate within their permissions, preventing unauthorized access to sensitive data and services.

In accordance with an embodiment, the identity function can be integrated within the cloud provider IAM service 1122, or the cloud provider IAM service 1122 may be federated to an external identity provider. When the identity service is part of the cloud provider IAM service 1122, cloud provider IAM service 1122 handles aspects of identity verification and management internally. When cloud provider IAM service 1122 is federated with an external identity provider (using protocols, such as SAML, OAuth, or OpenID Connect), the external identity provider is responsible for authenticating users, while the cloud provider IAM service 1122 manages access control policies. Federation allows organizations, such as the cloud reseller and customer organizations, to leverage existing identity infrastructures to manage the identity function, while leveraging the cloud provider IAM service 1122 for managing resources within their respective tenancies.

In one or more embodiments, cloud reseller identity provider 1140 may be federated with cloud provider IAM service 1122. In this configuration, the cloud reseller identity provider 1140 handles user authentication for cloud reseller users, issuing security tokens that the cloud provider IAM 1122 service recognizes. The cloud provider IAM service 1122 then uses these tokens to grant access to resources associated with cloud reseller tenancies 1114 based on predefined policies. This allows users to authenticate through the cloud reseller identity provider 1140, while the cloud service IAM service 1122 manages access control within the cloud environment. Federation ensures that authentication and authorization processes are decoupled, enabling the use of a centralized identity services across different platforms and applications for cloud reseller users.

In one or more embodiments, customer organization identity provider 1130 may be federated with cloud provider IAM service 1122. In this configuration, the customer organization identity provider 1130 handles user authentication for customer entity users, issuing security tokens that the cloud provider IAM 1122 service recognizes. As with the previous example, the cloud provider IAM service 1122 then uses these tokens to grant access to resources associated with customer organization tenancies 1116 based on predefined policies. This allows customer organization users to authenticate through the customer organization identity provider 1130, while the cloud service IAM service 1122 manages access control within the cloud environment.

In one or more embodiments, account service 1124 maintains account information associated with tenancies. For example, account service 1124 includes an interface that allows users and/or services to store, in an account metadata field, a unique tenancy owner identifier attribute that identifies the owner of a tenancy. Additional metadata fields may be used to store additional account attributes, including contact information and other organizational information about the owner of a tenancy. In an embodiment, account service 1124 maintains account information associated with cloud provider tenancies 1112, cloud reseller tenancies 1114, and customer organization tenancies 1116. Account metadata may be stored in metadata 1152 in data repository 1150 in accordance with one or more embodiments. In accordance with one or more embodiments, account metadata may include a subscription metadata field that identifies subscriptions for products and services. For example, a subscription metadata field may reference one or more subscriptions associated with the account.

In one or more embodiments, subscription service 1126 maintains subscription data 1154 that is stored in data repository 1150. Subscription service stores available cloud service offerings information that indicates the cloud services that an entity can subscribe to. For example, subscription service 1126 maintains a mapping between services available for the cloud reseller to purchase from the cloud provider and the prices that the cloud reseller will pay to the cloud provider for those services. For example, when a cloud reseller creates an internal tenancy within the region 1100, cloud reseller will pay a free for that tenancy as defined by subscription data 1154. In addition, subscription service 1126 maintains a mapping between services available for the customer organization(s) to purchase from the cloud reseller and the prices that the customer organization will pay to the cloud reseller for those services. Similar to the subscription relationship between the cloud reseller and the cloud provider, a subscription relationship will exist between the customer organization and the cloud reseller when a customer organization subscribes to services.

In accordance with one or more embodiments, subscription service 1126 includes an interface, such as an API, that allows an entity to control subscription offerings and prices, thereby updating subscription data 1154. For example, cloud provider may create a new type of offering related to compute resources or software applications that may be made available to cloud resellers, customer organizations (through cloud reseller), or both. When a new offering is created, the offering may be made available via the subscription service 1126. The subscription service 1126 may allow a user to subscribe to the service on behalf of their organization. For example, subscription data 1154 that indicates an offering available to a cloud reseller of a suite of financial services software may be viewable by select users associated with the cloud reseller. Subscription data 1154 that indicates an offering available to a customer organization of the same suite of financial services software may be viewable by select users associated with the customer organization. The price for the financial services software may be different for the cloud reseller than for customer organization(s), and this price difference can be reflected in subscription data 1154, managed by subscription service 1126.

In accordance with one or more embodiments, subscription service 1126 is controlled by the cloud provider and maintained within a cloud provider tenancy. However, subscription service 1126 is configured to provide access to subscription data 1154 based on access control policies in an embodiment. For example, in an embodiment, only the cloud provider and a cloud reseller are allowed to access subscription data corresponding to the relationship between the cloud reseller and the cloud provider. For example, the cloud provider and a cloud reseller are allowed to access information indicating the prices paid by the cloud reseller for services purchased from the cloud provider. As another example, only the cloud provider and the cloud reseller may access information indicating the services and other offerings that the cloud reseller has subscribed to, or purchased, from the cloud provider.

In accordance with one or more embodiments, subscription service 1126 maintains detailed subscription information (“subscriptions”) for products and services. In an embodiment, a subscription is stored as one or more subscription data fields that indicate the subscribing entity as well as the entity offering the product or service. For example, subscription data may be stored in subscription data 1154 and may reference account owners in a manner similar to the tenancy owner attribute discussed in connection with the account service 1124. A subscription may also include metadata fields identifying a product associated with the subscription, pricing, discounts, discount groups, and other subscription-related information. In accordance with one or more embodiments, subscription service 1126 may be part of account service 1124, and subscription data may be part of account metadata. Subscription data 1154 and metadata 1152 may also be combined in an embodiment.

In one or more embodiments, billing service 1128 generates bills and billing reports for the services associated with an entity, subscription, and/or tenancy. Billing service 1128 may access subscription data 1154 or other subscription-related information to determine the services that an entity has subscribed to. Billing service 1128 may also access information related to discounts, discount groups, rate card information associated with an entity, and resource utilization information.

In accordance with one or more embodiments, billing service 1128 generates a bill and/or report for customer organizations that have subscribed to services offered by the cloud reseller. Although billing service 1128 is a cloud provider service that is associated with a tenancy controlled by the cloud provider in an embodiment, bills associated with customer organizations of the cloud reseller are not accessible to the cloud provider. However, resource utilization is visible to the cloud provider, and a bill for resources associated with the region controlled by the cloud reseller, including customer organization tenancies 1116, will be generated for the cloud reseller. The result is that customer organizations receive a bill from the cloud reseller for their use of cloud resources in accordance with respective subscriptions, and the cloud reseller receives a bill from the cloud provider that represents aggregate resource use that includes cloud reseller tenancies 1114 and customer organization tenancies 1116. A subscription associated with cloud provider tenancies is between the cloud provider and itself, and therefore may result in the billing service 1128 generating a report rather than a bill in an embodiment.

In one or more embodiments, order management service 1129 receives and processes orders for services and creates tenancies based on the requirements of the requesting entity. For example, a cloud reseller can define specific configurations and resource allocations necessary for their end customers (customer organizations). Order management service 1129 initializes the setup of the tenancy, deploying the required infrastructure components, including virtual networks, compute instances, storage systems, and associated networking elements. Each component is configured to meet the specified requirements, ensuring that the resources are allocated correctly and efficiently. Security and compliance settings are applied according to the reseller's specifications, including firewall rules, encryption standards, and audit logging configurations to ensure the tenancy adheres to organizational policies and regulatory requirements. The process involves automated orchestration to provision resources rapidly while maintaining consistency and reliability.

In accordance with one or more embodiments, a newly created tenancy is isolated from others, providing a secure and independent environment. The order management service 1129 integrates with identity providers and IAM systems to establish user roles and permissions within the tenancy. This integration allows for the creation of detailed access control policies that define who can access specific resources and what actions they can perform. Permissions are configured to align with the cloud reseller's operational needs, enabling control over access to compute, storage, and networking resources. The resulting tenancy is fully configured, allowing the cloud reseller to manage and utilize the environment for their clients' diverse needs, supporting various workloads and applications. The tenancy is associated with a subscription that informs billing service 1128 for billing purposes.

In one or more embodiments, a data repository 1150 is any type of storage unit and/or device (e.g., a file system, database, collection of tables, or any other storage mechanism) for storing data. Furthermore, a data repository 1150 may include multiple different storage units and/or devices. The multiple different storage units and/or devices may or may not be of the same type or located at the same physical site. Furthermore, a data repository 1150 may be implemented or executed on the same computing system as any one of the cloud provider services 1120. Additionally, or alternatively, a data repository 1150 may be implemented or executed on a computing system separate from the cloud provider services 1120. The data repository 1150 may be communicatively coupled to region 1110 via a direct connection or via a network.

Information describing metadata 1152 and subscription data 1154 may be implemented across any of components within the region 1110 or cloud provider services 1120. However, this information is illustrated within the data repository 1150 for purposes of clarity and explanation.

In an embodiment, the cloud environment described herein, including services, tenancies, data repositories, and other elements described in connection with FIG. 11, is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, one or more interfaces may be used for communication between services, tenancies, or other elements described herein. The term “interface” refers to hardware and/or software configured to facilitate communications between a user (or service) service and a service or tenancy. An interface can render user interface elements and receive input via user interface elements or API calls. Examples of interfaces include a graphical user interface (GUI), a command line interface (CLI), a haptic interface, and a voice command interface or an API. Examples of user interface elements include checkboxes, radio buttons, dropdown lists, list boxes, buttons, toggles, text fields, date and time selectors, command lines, sliders, pages, and forms.

In an embodiment, different components of interfaces are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interfaces are specified in one or more other languages, such as Java, C, or C++.

In one or more embodiments, a tenant (such as tenant associated with a tenancy in region 1110) is a corporation, organization, enterprise, or other entity that accesses a shared computing resource, such as data repository 1150 or cloud provider IAM service 1122. In an embodiment, tenants may be independent from each other. For example, many separate customer organizations may be tenants having their own respective tenancies in customer organization tenancies 1116. A business or operation of one tenant is separate from a business or operation of another tenant.

### 4. IMPLEMENTING TENANCIES OF DIFFERENT TYPES

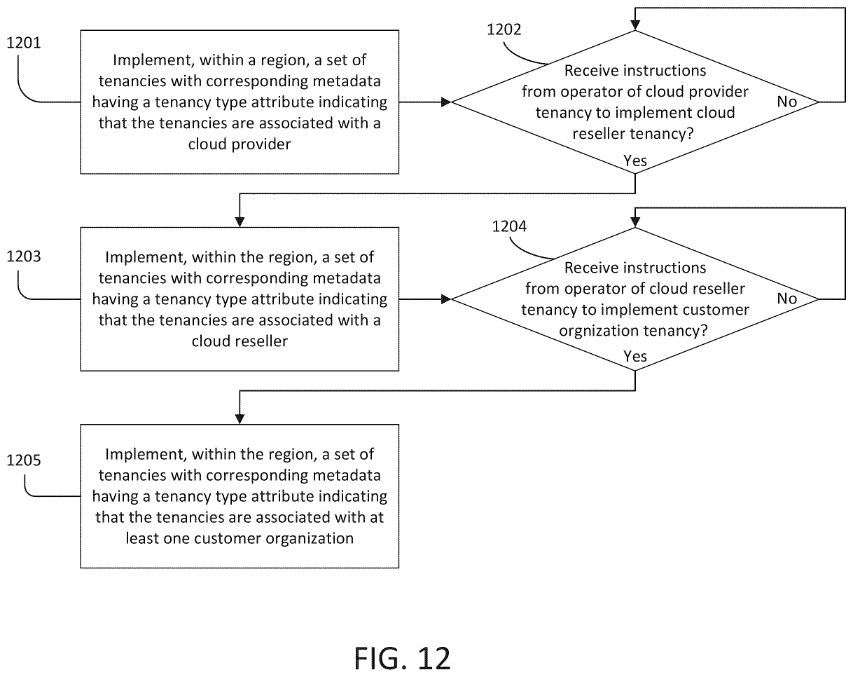

FIG. 12 illustrates an example set of operations for implementing tenancies of multiple types in a cloud environment in accordance with one or more embodiments. One or more operations illustrated in FIG. 12 may be modified, rearranged, or omitted. Accordingly, the particular sequence of operations illustrated in FIG. 12 should not be construed as limiting the scope of one or more embodiments.

In accordance with one or more embodiments, a cloud provider receives an order for a region from a cloud reseller. The order may indicate the resources needed for the region, one or more data centers to be used, compliance requirements, ownership, and other information associated with the order. The order may be received via a user interface or some other method.

In response to receiving this order, the cloud provider performs a region build operation. In an embodiment, the region build operation is performed by a region build service that is part of order management service 1129. In another embodiment, the region build service is separate from order management service 1129. During the region build process, a region is instantiated.

In an embodiment, the system implements, within a region, a set of tenancies with corresponding metadata having a tenancy type attribute indicating that the tenancies are associated with a cloud provider (Operation 1201). For example, tenancies that include services required for operating the region are created. These services may include one or more cloud provider services 1120 in an embodiment. Metadata indicating the tenancy type may be stored in any manner that effectively associates the tenancies with a particular tenancy type, including a type identifier, text indicating the type, or a flag to be interpreted as a type. In an embodiment, metadata may use “provider” as a tenancy type for the cloud provider. In another embodiment, the type of tenancy may be “internal” or “external” from the point of view of the cloud reseller.

In accordance with one or more embodiments, account service 1124 manages information about tenancies. For example, an account may be created using account service 1124, and one or more contacts may be associated with the account. For example, accounts may be associated with an administrator email, company information, and other contact information about the tenant. Each account is also associated with a unique account identifier. The account service 1124 may also be used to define and store data associated with a tenancy. For example, a tenancy name or other tenancy information like tenancy classifications used for compliance purposes may be maintained by account service 1124.

In accordance with one or more embodiments, more than one tenancy associated with the cloud provider may be created during the region build process. In an embodiment, these cloud provider tenancies 1112 include cloud provider services 1120, such as the cloud provider IAM service, account service 1124, subscription service 1126, billing service 1128, and order management service 1129.

In an embodiment, the system may or may not receive instructions from an operator of a cloud provider tenancy to implement a cloud reseller tenancy (Operation 1202). If not, then the system will continue to await such instructions. If so, then the system creates a cloud reseller tenancy in an embodiment. In an embodiment, the instructions from an operator of the cloud provider tenancy may indicate the conditions under which the cloud reseller tenancy may be created. For example, the instructions may indicate that the cloud reseller tenancy may be created after the cloud reseller tenancy satisfies certain requirements and sends a request. In such an embodiment, the request from the cloud reseller completes the instructions from the cloud provider.

In an embodiment, the system implements, within the region, a set of tenancies with corresponding metadata having a tenancy type attribute indicating that the tenancies are associated with a cloud reseller (Operation 1203). For example, an initial tenancy created during the region build process that is a management tenancy may be associated with the cloud reseller. The term “initial tenancy” identifies the tenancy as the first tenancy created in the region that is created for the cloud reseller. Before the creation of the initial tenancy, other tenancies in the region were created for and associated with the cloud provider.

In accordance with one or more embodiments, the initial tenancy is associated with the cloud provider upon its creation but is configured to be associated with the cloud reseller when control of the region is handed over to the cloud reseller. The hand-off process includes the following: updating the account metadata associated with the initial tenancy to reference the cloud reseller; updating the subscription metadata to reference detailed subscription data showing the cloud reseller as the subscriber and the cloud provider as the subscription offering entity; and updating the metadata attribute expressing the tenancy type to indicate that the type of tenancy is internal to the cloud reseller. In accordance with one or more embodiments, subscription metadata includes a reference to both the subscriber and the subscription-offering entity.

Cloud resellers may initiate the creation of additional internal tenancies in accordance with an embodiment. For example, a cloud reseller may have proprietary systems, services, or other offerings for their customers that need to run in a tenancy other than the initial management tenancy. A cloud reseller may also have a business need to run applications, such as finance applications or other business-specific applications, in separate tenancies to create a logical separation of the applications.

In accordance with one or more embodiments, a cloud reseller may initiate the creation of a new internal tenancy using the order management service 1129. An order includes information about the tenancy to be created, resource requirements, tenancy ownership, and other attributes needed to create the tenancy. Using these attributes, order management service orchestrates the creation of a new internal tenancy for the cloud reseller. Account service 1124 stores associated account metadata for the new tenancy. Account service 1124 stores metadata attributes indicating that the new tenancy is an internal tenancy associated with the cloud reseller.

In accordance with one or more embodiments, account metadata also includes a tenancy type attribute that indicates a tenancy type for tenancies. The metadata field (tenancy type field) for the tenancy type attribute may be populated with values (or references to values), such as cloud provider, cloud reseller, and end customer. In an embodiment, the tenancy type field may additionally be populated with a value indicating if the tenancy type is internal or external.

In accordance with one or more embodiments, the value in the tenancy type field is used by cloud provider IAM service 1122 to distinguish between access privileges available for services in the associated tenancy. For example, a tenancy associated with the “cloud provider” tenancy type may include a resource limit service that is able to set limits on resource usage within the region. Users associated with the cloud provider may be unrestricted when using the resource limit service based on access privileges configured in cloud provider IAM service 1122. The unrestricted privileges may result, for example, from the user affiliation with the entity type associated with the tenancy. In this case, users associated with the cloud provider are able to set limits on use within the region. Given the same scenario, users associated with the cloud reseller will not have the same privileges because they are not associated with the cloud provider entity but are instead associated with the cloud reseller entity. Users associated with the cloud reseller may, however, be able to use the resource limit service to enforce limits on resource usage by customer organizations and by the cloud reseller itself.

To expand on the previous example, a reporting service in a tenancy with the type “cloud reseller” may be used with no restrictions by a user associated with the cloud reseller in accordance with one or more embodiments. In addition, users associated with customer organizations may have privileges to use the reporting service. However, users associated with the cloud provider may not have permission to use the reporting service. Likewise, resources in tenancies with a tenancy type “end customer” may be associated with different permissions based on user affiliation. These examples illustrate that authorization associated with tenancies having type attributes is not purely hierarchical.

In accordance with an embodiment, the tenancy type attribute may be used by cloud provider IAM service to grant users greater or different privileges associated with a service in a tenancy that is assigned a type for which the user typically has fewer privileges. For example, a user associated with a cloud reseller may use a reporting service that is in a tenancy having a “cloud provider” type. Even though the reporting service is associated with the cloud provider, the cloud reseller may have access to detailed and specific reporting information (e.g., shows resource usage by user and customer organization), while users associated with the cloud provider only have access to aggregate reporting information. This type of access restriction helps to preserve the confidential nature of the data involved, while providing the access necessary based on a combination of user organization and tenancy type.

In an embodiment, the system may or may not receive instructions from an operator of a cloud reseller tenancy to implement a customer organization tenancy (Operation 1204). If not, then the system will continue to await such instructions. If so, then the system creates a customer organization tenancy in an embodiment. In an embodiment, the instructions from an operator of the cloud reseller tenancy may indicate the conditions under which the customer organization tenancy may be created. For example, the instructions may indicate that the customer organization tenancy may be created after the operator of the customer organization tenancy satisfies certain requirements and sends a request. In such an embodiment, the request from the customer organization completes the instructions from the cloud reseller.

In an embodiment, the system implements, within the region, a set of tenancies with corresponding metadata having a tenancy type attribute indicating that the tenancies are associated with at least one customer organization (Operation 1205). In an embodiment, new tenancies for customers of the cloud reseller (customer organizations) may initiate an order to create a new tenancy. In an embodiment, a user associated with a customer organization may submit an order via order management service 1129.

In accordance with one or more embodiments, although order management service 1129 and other cloud provider services 1120 are controlled by the cloud provider, they have been configured to offer services to both cloud resellers and customer organizations. For example, order management service 1129 may allow users associated with a cloud reseller to create internal tenancies associated with either the cloud reseller or customer organizations. Users associated with customer organizations, on the other hand, may not create tenancies on behalf of the cloud reseller but may place an order for a new tenancy to be created for the use of the customer organization. When a user associated with a customer organization places an order, the order includes information about the tenancy to be created, resource requirements, tenancy ownership, and other attributes needed to create the tenancy.

In accordance with one or more embodiments, order management service orchestrates the generation of a new tenancy. Using the attributes provided in the order, order management service orchestrates the creation of a new internal tenancy for the customer organization. Account service 1124 stores associated account metadata for the new tenancy. Subscription service 1129 stores metadata attributes indicating that the new tenancy is an external tenancy that is associated with the customer organization. The new tenancy associated with the customer organization is labeled an external tenancy because it is external to the owner of the region (the cloud reseller).

In an embodiment, cloud provider tenancies have policies that allow the cloud reseller and/or the customer organizations restricted use of services provided by the cloud provider. For example, application services that provide access to applications made available by cloud provider may be accessible by both the cloud reseller and the customer organization. However, pricing of applications, tenancies, resources, and other services is dependent on the type of tenancy, subscribing entity, and/or subscription provider.

In accordance with one or more embodiments, cloud provider IAM service 1122 is another service controlled by the cloud provider that may be used by users of the cloud reseller or users of a customer organization (consistent with policy restrictions). The cloud provider IAM service controls access to resources within the region and stores permissions and access policies in a centralized directory. It defines and manages roles and groups, assigning specific permissions to each based on organizational needs. Users and applications may also authenticate through the IAM service in an embodiment, resulting in identity verification and permissions check before granting access to requested resources. This ensures that interactions with the cloud environment are restricted to authorized entities.

In an embodiment, cloud provider IAM service 1122 is federated with one or more external identity providers. For example, an order by a cloud reseller may indicate that cloud reseller identity provider 1140 should be used to authenticate users associated with the cloud reseller. The preferred identity provider is stored in metadata associated with the tenancy, and cloud provider IAM service 1122 is federated to the cloud reseller identity provider 1140. When a user or service attempts to access a resource in the cloud reseller tenancy, authentication is performed by the cloud reseller identity provider 1140, and authorization is granted or denied by cloud provider IAM service 1122 based on policies associated with cloud provider IAM service 1122.

In an embodiment, the system generates subscription data indicating that subscriptions for the cloud provider are between the cloud provider and the cloud provider itself. Account service 1124 creates subscription metadata to associate subscriptions with the account of the entity requesting the creation of the new tenancy. The subscription data associated with the subscription includes subscription attributes that indicate a subscribing entity and a subscription offering entity. In the case of a cloud provider tenancy, the subscribing entity and the subscription offering entity will both reference the cloud provider account identifier since the cloud provider is both the subscription offering entity and the subscribing entity.

In an embodiment, when a new internal tenancy is created for the cloud reseller, the system generates subscription data indicating that subscriptions for the cloud reseller are between the cloud reseller and the cloud provider. Subscription service 1129 stores data attributes indicating that the cloud reseller is the subscriber associated with the tenancy, and the cloud provider is the subscription offering entity. Since the subscription is between the cloud reseller and the cloud provider, the cloud reseller will be billed for the resource usage associated with the subscription. Resource usage is logged and stored in data repository 1150 in an embodiment. Based on the subscription, the resource usage is attributed to the subscriber. Billing service 1128 accesses the usage information and uses the usage information to generate bills for subscribers.

In an embodiment, the system generates subscription data indicating that subscriptions for customer organization are between the customer organization and the cloud reseller. Subscription service 1129 stores metadata attributes indicating that the customer organization is the subscriber associated with the tenancy, and the cloud reseller is the subscription offering entity. Since the subscription is between the customer organization and the cloud reseller, the customer organization will be billed for the resource usage associated with the subscription. Resource usage is logged and stored in data repository 1150 in an embodiment. Based on the subscription, the resource usage is attributed to the subscriber.

In an embodiment, a cloud reseller may initiate the creation, and the system can create any number of internal tenancies that are associated with the cloud reseller provided that the number of tenancies does not exceed an amount preconfigured with the system by the cloud provider. Likewise, a customer organization reseller may initiate the creation, and the system can create any number of internal tenancies that are associated with the cloud reseller provided that the number of tenancies does not exceed an amount preconfigured with the system by the cloud provider or by the cloud reseller.

In accordance with one or more embodiments, tenancies may be created in a region for any number of customer organizations that are customers of the cloud reseller provided that the number of customer organizations and resource utilization does not exceed limits preconfigured with the system by the cloud provider or by the cloud reseller. Each customer organization may have its own identity provider in an embodiment. For example, tenancies associated with customer organization A may use an identity provider A, while tenancies associated with customer organization B may use an identity provider B. In this example, both identity provider A and identity provider B are federated with cloud provider IAM service 1122 with cloud provider IAM service 1122 configured to ensure that the appropriate identity service is used for the tenancies associated with each customer organization.

In accordance with one or more embodiments, a cloud reseller may initiate external orders on behalf of customer organizations. For example, a representative of a customer organization may request that the cloud reseller create a tenancy on behalf of the customer organization. In such a case, the cloud reseller will initiate an order for a tenancy to order management system 1129 on behalf of the customer organization, referencing account metadata for the customer organization in the order. In addition, the order may include information related to the identity provider for the customer organization, resource requirements, and any other information required to initiate the creation of a tenancy.

In accordance with one or more embodiments, cloud provider services, such as order management system 1129, may be used by the cloud provider, the cloud reseller, and customer organizations. Once ownership of the region is handed over to the cloud reseller, restrictions are placed on users associated with the cloud provider with respect to managing the region. The restrictions are configured in cloud provider IAM service 1122 and may extend to one or more cloud provider services 1120. For example, users associated with the cloud provider are authorized to create new cloud provider tenancies but are restricted from creating new tenancies associated with the cloud reseller or customer organizations in an embodiment. As another example, users associated with the cloud provider are restricted from viewing rate card information and billing information in an embodiment. However, certain restrictions apply to the cloud reseller in embodiments. For example, cloud resellers may not alter tenancies that are associated with the cloud provider. Similarly, users associated with the cloud reseller are restricted from accessing tenancies associated with customer organizations in an embodiment. However, users associated with the cloud reseller may place restrictions on the use of cloud resources by customer organization tenancies, and users associated with the cloud provider may place restrictions on the use of cloud resources by cloud reseller tenancies and customer organization tenancies in an embodiment.

In one or more embodiments, each tenancy is associated with one or more respective administrators. For example, if the group of cloud reseller tenancies 1114 includes four separate tenancies in an embodiment; each of the four separate tenancies includes at least one administrator in that embodiment. Each administrator has permission to access all resources within a tenancy associated with that administrator in an embodiment. In an embodiment, each administrator belongs to the organization corresponding to the tenancy being administered. In an embodiment, a user or administrator may be associated with one or more organizations, including a cloud provider, a cloud reseller, or one or more customer organizations.

### 5. TENANCY CONVERSION IN A CLOUD ENVIRONMENT

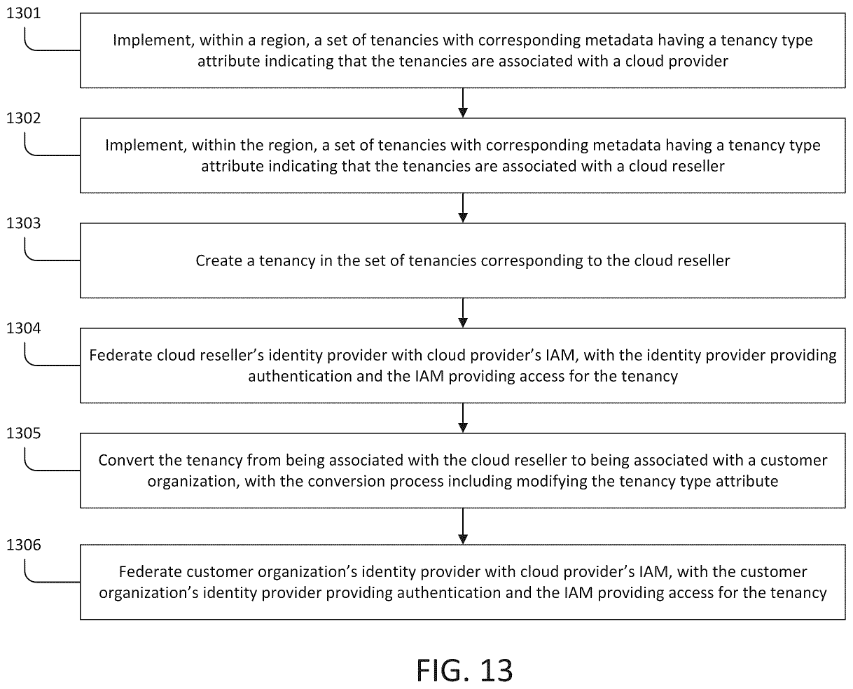

FIG. 13 illustrates an example set of operations for performing a tenancy type conversion in a cloud environment in accordance with one or more embodiments. One or more operations illustrated in FIG. 13 may be modified, rearranged, or omitted. Accordingly, the particular sequence of operations illustrated in FIG. 13 should not be construed as limiting the scope of one or more embodiments.

In an embodiment, the system implements, within a region, a set of tenancies with corresponding metadata having a tenancy type attribute, indicating that the tenancies are associated with a cloud provider (Operation 1301). For example, tenancies that include services required for operating the region are created. These services may include one or more cloud provider services 1120 in an embodiment. Metadata indicating the tenancy type may be stored in any manner that effectively associates the tenancies with a particular tenancy type, including a type identifier, text indicating the type, or a flag to be interpreted as a type. In an embodiment, metadata may use “provider” as a tenancy type for the cloud provider. In another embodiment, the type of tenancy may be “internal” or “external” from the point of view of the cloud reseller.

In an embodiment, the system implements, within the region, a set of tenancies with corresponding metadata having a tenancy type attribute indicating that the tenancies are associated with a cloud reseller (Operation 1302). For example, the cloud reseller may initiate the creation of several new internal tenancies using the order management service 1129. An order includes information about the tenancies to be created, resource requirements, tenancy ownership, and other attributes needed to create the tenancies. Using these attributes, order management service orchestrates the creation of the set of internal tenancies for the cloud reseller. Account service 1124 stores associated account metadata for the set of tenancies. Subscription service 1129 stores respective metadata attributes for the tenancies, indicating that the tenancies are internal tenancies associated with the cloud reseller. The tenancies in the set of tenancies may be used to offer services to customer organizations, such as software products, reporting services, analysis services, or customized interfaces to third party services, for example. The tenancies in the set of tenancies may also be used to support cloud reseller operations or otherwise for the benefit of the cloud reseller.

In an embodiment, the system creates a tenancy in the set of tenancies corresponding to the cloud reseller (Operation 1303). For example, the cloud reseller may initiate the creation of a new internal tenancy using the order management service 1129 following the steps described in the previous operation. The result is the creation of an additional internal tenancy associated with the cloud reseller. The newly created tenancy may be used as a demonstration tenancy, for example. A demonstration tenancy may be used as a sales tool to demonstrate the capabilities of the cloud infrastructure system, such as performance, available services, management features, and resource availability. In an embodiment, since the newly created demonstration tenancy is an internal tenancy, the tenancy type attribute in the account metadata associated with the tenancy is populated with a value indicating that the demonstration tenancy is an internal tenancy (e.g., “internal”). In addition, the owner attribute in the account metadata associated with the demonstration tenancy references the cloud reseller using a unique identifier associated with the cloud reseller.

In an embodiment, the system federates the cloud reseller's identity provider with cloud provider's IAM, with the identity provider providing authentication and the IAM providing access for the tenancy (Operation 1304). For example, although the purpose of creating the demonstration tenancy may be to demonstrate the services available within the cloud infrastructure environment, the demonstrators are affiliated with the cloud reseller. Because of this, users associated with the cloud reseller will use the cloud reseller identity provider 1130 to authenticate, and will use cloud provider IAM service 1130 to provide authorization services.

In an embodiment, the system converts the tenancy from being associated with the cloud reseller to being associated with a customer organization, with the conversion process including modifying the tenancy type attribute (Operation 1305). For example, the demonstration tenancy may have been used to demonstrate complex operations that involve installing software, creating services, loading data, and performance of other processes. By converting the tenancy to an external tenancy that is associated with the customer for which the demonstration tenancy was created, the steps used to create the tenancy and the demonstration environment will not need to be executed again.

A tenancy conversion module within order management service or another cloud provider service may be instructed to perform the conversion process. In response to receiving a well-formed conversion request from the cloud reseller or the customer organization (if permitted to do so by an administrator for the cloud reseller), the tenancy conversion module updates the tenancy type attribute in the account metadata associated with the tenancy, populating the tenancy type attribute with a value indicating that the demonstration tenancy is an external tenancy (e.g., “external”).

In an embodiment, the tenancy type attribute is used to determine if the cloud reseller is solely responsible for the costs associated with the tenancy or if the costs should be passed on to an external party such as a customer organization. For example, when billing service 1128 accesses resource usage information, it will assume that internal tenancies are the sole responsibility of the cloud reseller for billing purposes in an embodiment. Although the owner attribute in the account metadata may be used for billing purposes in an embodiment, using both allows the cloud reseller to remain responsible for the costs while assigning ownership to the customer organization in an embodiment, resulting in a partial conversion. A partial conversion may be used to facilitate trial periods, promotional periods, or provide services for which the cloud reseller determines are in its best interest. In an embodiment, the owner attribute in the account metadata associated with the demonstration tenancy is updated to reference the customer organization using a unique identifier associated with the customer organization.

In an embodiment, the system federates the customer organization's identity provider with the cloud provider's IAM, with the customer organization's identity provider providing authentication and the cloud provider's IAM providing access for the tenancy (Operation 1306). The cloud provider IAM service 1122 is then configured to ensure that authentication is performed by the customer organization's identity provider. At the same time, The cloud provider IAM service 1122 is configured to ensure that authentication performed by the cloud reseller identity provider 1140 is insufficient for accessing the converted tenancy.

In accordance with one or more embodiments, during the conversion process, any options that are available during the tenancy order process are available. For example, the demonstration tenancy may initially be based on significant resource requirements, such as compute or storage requirements. If the allocation of resources is unnecessary and would result in a significant expense to the customer organization after the conversion process, changes in these allocations may be made during the conversion process.

### 6. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations for implementing a cloud environment, comprising:
implementing a first set of one or more tenancies, wherein respective metadata associated with the first set of one or more tenancies indicates that each of the first set of one or more tenancies is associated with a cloud provider;
implementing a second set of one or more tenancies, wherein respective metadata associated with the second set of one or more tenancies indicates that each of the second set of one or more tenancies is associated with a cloud reseller; and
implementing a third set of one or more tenancies, wherein respective metadata associated with the third set of one or more tenancies indicates that each of the third set of one or more tenancies is associated with at least one of a plurality of customer organizations of the cloud reseller.

2. The non-transitory computer readable media of claim 1, wherein a service maintains the metadata associated with the first set of tenancies, the metadata associated with the second set of tenancies, and the metadata associated with the third set of tenancies.

3. The non-transitory computer readable media of claim 1, wherein the metadata includes a tenancy type attribute, and the tenancy type field can be populated by a value indicating at least one of the following tenancy types: cloud provider, cloud reseller, end customer.

4. The non-transitory computer readable media of claim 3, wherein the value of the tenancy type field can further indicate that the tenancy type is an internal tenancy.

5. The non-transitory computer readable media of claim 3, further comprising:
creating a tenancy of the second set of tenancies as part of a region build process.

6. The non-transitory computer readable media of claim 1, wherein:
wherein subscriptions of the first set of tenancies are between the cloud provider and the cloud provider itself;
wherein subscriptions of the second set of tenancies are between the cloud reseller and the cloud provider; and
wherein subscriptions of the third set of tenancies are between the at least one of a plurality of customer organizations and the cloud reseller.

7. The non-transitory computer readable media of claim 6, wherein parties to subscriptions are determined by an accounts based at least in part on a subscription metadata field associated with an accounts service.

8. The non-transitory computer readable media of claim 7, wherein the operations further comprise:
enforcing permissions to resources within the first set of tenancies, or the second set of tenancies, or the third set of tenancies, based at least in part on the value of the subscription metadata field associated with the accounts service.

9. The non-transitory computer readable media of claim 8, wherein the subscription between the cloud reseller and the cloud provider indicates that resource usage associated with the second set of tenancies is billed from the cloud provider to the cloud reseller.

10. The non-transitory computer-readable media of claim 6, wherein the operations further comprise:
implementing a fourth set of tenancies, wherein respective metadata associated with the fourth set of one or more tenancies indicates that each of the fourth set of one or more tenancies is associated with the cloud reseller;
wherein subscriptions of the fourth set of tenancies are between the cloud reseller and the cloud provider.

11. The non-transitory computer readable media of claim 10, wherein the operations further comprise:
creating a tenancy of the fourth set of tenancies responsive to an internal order submitted by the cloud reseller.

12. The non-transitory computer readable media of claim 11, wherein the operations further comprise:
converting a tenancy from being within the fourth set of tenancies to being within the third set of tenancies, wherein converting comprises modifying the tenancy type attribute from a value indicating cloud reseller to a value indicating end customer.

13. The non-transitory computer readable media of claim 12, wherein creating the tenancy comprises:
federating a first identity provider with a first IAM, wherein the first identity provider is associated with the cloud reseller and the IAM is associated with the cloud provider; and
wherein the first identity provider provides authentication for the tenancy and the IAM provides authorization for the tenancy.

14. The non-transitory computer readable media of claim 13, wherein converting the tenancy further comprises:
federating a second identity provider with the first IAM, wherein the second identity provider is associated with a customer organization of the plurality of customer organizations; and
wherein the second identity provider provides authentication for the tenancy and the IAM provides authorization for the tenancy.

15. The non-transitory computer readable media of claim 11, wherein the operations further comprise:
creating a tenancy of the third set of tenancies responsive to an external order submitted by the cloud reseller; and
wherein the internal order and the external order are submitted by the cloud reseller to a same order management system.

16. The non-transitory computer readable media of claim 1, wherein the metadata includes a tenancy owner identifier attribute, and the tenancy owner identifier field indicates a unique identifier associated with a tenancy owner.

17. The non-transitory computer readable media of claim 1, wherein the operations further comprise:
creating a tenancy of the third set of tenancies responsive to an external order submitted by the cloud reseller.

18. The non-transitory computer readable media of claim 1, wherein the operations further comprise:
federating an identity provider associated with a customer organization of the plurality of customer organizations with the IAM of the cloud provider, such that the identity provider provides authentication for the tenancy of the third set of tenancies and the IAM provides authorization for the tenancy.

19. The non-transitory computer readable media of claim 1, wherein:
each tenancy in the first set of tenancies, or the second set of tenancies, or the third set of tenancies, is associated with one or more respective administrators;
each respective administrator has permissions to access all resources within a tenancy associated with that administrator;
each administrator associated with the first set of tenancies is associated with a cloud provider;
each administrator associated with the second set of tenancies is associated with a cloud reseller; and
each administrator associated with the third set of tenancies is associated with a customer organization of the plurality of customer organizations.

20. A method, comprising:
implementing a first set of one or more tenancies, wherein respective metadata associated with the first set of one or more tenancies includes a tenancy type attribute, and the tenancy type attribute indicates that each of the first set of one or more tenancies is associated with a cloud provider;
implementing a second set of one or more tenancies, wherein respective metadata associated with the second set of one or more tenancies indicates that each of the second set of one or more tenancies is associated with a cloud reseller;
implementing a third set of one or more tenancies, wherein respective metadata associated with the third set of one or more tenancies indicates that each of the third set of one or more tenancies is associated with at least one of a plurality of customer organizations of the cloud reseller; and
wherein the method is performed by at least one device including a hardware processor.

21. A system comprising:
at least one device including a hardware processor;
the system being configured to perform operations comprising:
implementing a first set of one or more tenancies, wherein respective metadata associated with the first set of one or more tenancies includes a tenancy type attribute, and the tenancy type attribute indicates that each of the first set of one or more tenancies is associated with a cloud provider;
implementing a second set of one or more tenancies, wherein respective metadata associated with the second set of one or more tenancies indicates that each of the second set of one or more tenancies is associated with a cloud reseller; and
implementing a third set of one or more tenancies, wherein respective metadata associated with the third set of one or more tenancies indicates that each of the third set of one or more tenancies is associated with at least one of a plurality of customer organizations of the cloud reseller.
